(19) United States
(12) Patent Application Publication
(10) Pub. No.: US 2026/0285251 A1
(43) Pub. Date: Sep. 24, 2026

(54) AIRBAG MODULE WITH FLAMING AND SHOCKWAVE MITIGATION

(71) Applicant: Toyoda Gosei Co., Ltd., Kiyosu-Shi (JP)

(72) Inventors: Roy Peter Deutschmann, South Lyon, MI (US); Roland Dominic Furtado, Novi, MI (US); Srinivas Krishnan, Troy, MI (US); David Lee Guyton, JR., Commerce Township, MI (US)

(21) Appl. No.: 19/086,597

(22) Filed: Mar. 21, 2025

(51) Int. Cl. B60R 21/217; B60R 21/2338; B60R 21/26; B60R 21/264

(52) U.S. Cl. CPC B60R 21/217; B60R 21/2338; B60R 21/264; B60R 2021/23384; B60R 2021/26029

(57) ABSTRACT

An airbag module includes an airbag housing having a through-opening formed in an outer wall of the housing. An igniter is operatively connected to the housing so that activation of the igniter produces shockwaves causing separation of a tether extending between the igniter and the through-opening, at least a portion of the shockwaves also passing through the through-opening and into an interior of the housing. Portions of the module may be structured to mitigate or dissipate the intensity of the shockwaves prior to the shockwaves passing into the housing interior and/or to delay propagation of the shockwaves into the housing interior. This may help minimize effects on the airbag due to passage of the shockwaves and other igniter by-products into the housing interior.

### FIELD

The subject matter described herein relates in general to airbags and, more particularly, to airbag tethers and associated tether separation mechanisms.

### BACKGROUND

Airbags are used in vehicles to protect vehicle occupants. During a crash event, the airbag is configured to rapidly inflate to provide soft cushioning and restraint for a vehicle occupant. The airbag provides an energy-absorbing surface between a vehicle occupant and one or more relatively hard vehicle structures (e.g., a steering wheel, instrument panel, body pillar, headliner, and windshield). A tether may be attached to the airbag to restrict the deployed geometry of the airbag in certain crash scenarios. In other scenarios where such control is not needed or desired, the tether may be broken or separated prior to or during airbag deployment to allow the airbag to deploy without restriction.

### SUMMARY

In one respect, the present disclosure is directed to an airbag module. The airbag module includes an airbag housing including a through-opening formed in an outer wall of the housing. An igniter is operatively connected to the housing so that activation of the igniter produces shockwaves causing separation of a tether extending between the igniter and the through-opening, at least a portion of the shockwaves also passing through the through-opening and into an interior of the housing.

### BRIEF DESCRIPTION OF THE DRAWINGS

FIG. 1 is a schematic perspective view of a portion of an airbag module in accordance with an embodiment described herein.

FIG. 2 is the perspective view of FIG. 1, showing portions of an airbag tether and an igniter in hidden lines.

FIG. 3A is a schematic cross-sectional view of the portion of the airbag housing module shown in FIGS. 1 and 2, showing the airbag folded in the interior of the airbag housing prior to deployment.

FIG. 3B is the schematic cross-sectional view of FIG. 3A, showing activation of the igniter and the resulting separation of the tether prior to (or simultaneous with) activation of the airbag inflator and after the start of airbag deployment.

FIG. 4 is a schematic plan view of the portion of the airbag module shown in FIGS. 1-3A, showing relative sizes and spatial relationships of the housing vent passage, the igniter, and the tether width in accordance with one or more arrangements described herein.

### DETAILED DESCRIPTION

An airbag module includes an airbag housing having a through-opening in the form of a vent passage formed in an outer wall of the housing. An igniter is operatively connected to the housing so that activation of the igniter produces shockwaves causing separation of a tether extending between the igniter and the through-opening, at least a portion of the shockwaves also passing through the through-opening and into an interior of the housing. Portions of the module may be structured to mitigate or dissipate the intensity of the shockwaves prior to the shockwaves passing into the housing interior and/or to delay propagation of the shockwaves into the housing interior. The structure described may ensure rapid and reliable separation of the tether and confine flaming produced by activation of the igniter, while minimizing or eliminating effects of igniter activation on the deploying airbag.

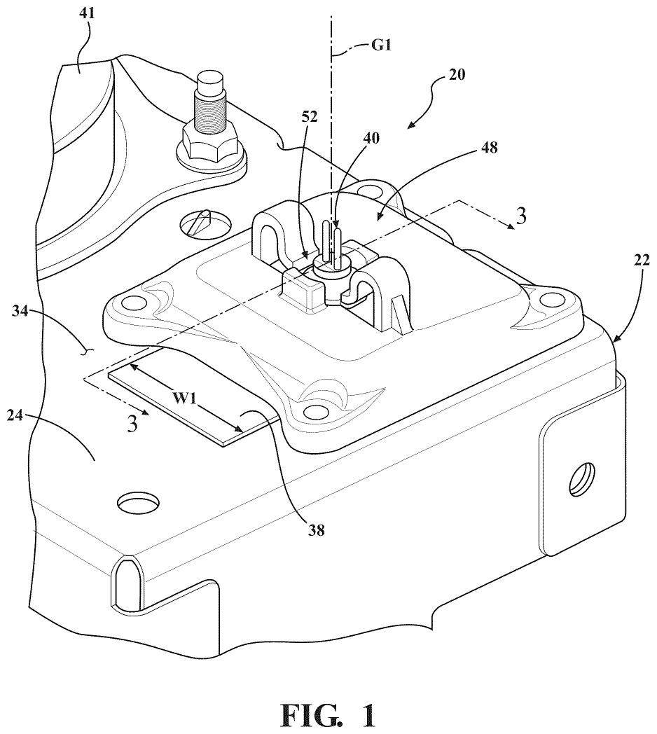

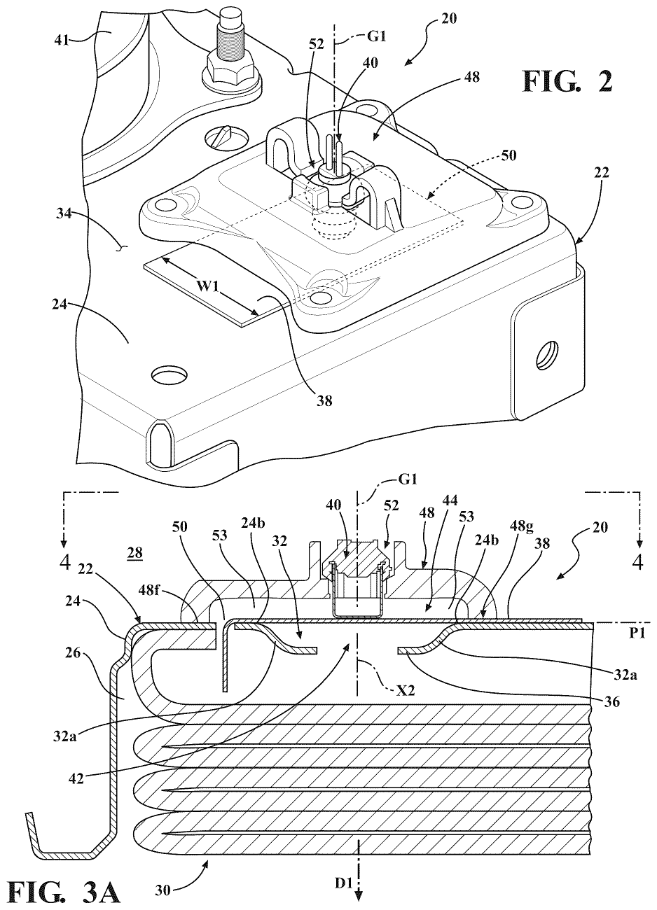

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various examples are shown in FIGS. 1-3, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIGS. 1-3, an example of an airbag module 20 is shown. The airbag module 20 may include an airbag module housing 22. As used herein, the term “airbag module housing” refers to a housing which is structured to store a folded inflatable airbag therein prior to airbag deployment.

The housing 22 may include an outer wall 24 defining an interior 26 of the housing. 22 The outer wall 24 is a wall separating the interior 26 of the housing 22 from an exterior 28 of housing. The housing interior 26 is a portion of the housing 22 structured to receive and store an inflatable airbag 30 therein prior to airbag deployment. In one or more arrangements, a depression or cavity 32 may be formed in the outer wall 24 along the housing exterior 28. The depression 32 may extend from a surface 34 of the outer wall 24 surrounding the depression in a direction D1 toward the housing interior 26 where the airbag 30 is to be positioned.

In one or more arrangements, the depression 32 may include one or more sidewalls 32a extending from a flat plane P1 defined by the outer wall surface 34 toward the housing interior 26 and terminating in a floor 36 of the depression 32. As described herein, the depression 32 may be structured to accommodate expansion and dissipation of flaming and may contribute to the dissipation of shock waves that have broken an airbag tether 38 (described in greater detail below) resulting from activation of an igniter 40 (also described in greater detail below). The optimal size, shape and/or other characteristics of the depression 32 for providing desired flaming dissipation and shockwave dissipation effects may be determined analytically and/or by experimentation using known methods. In one or more arrangements, the depression floor 36 may extend parallel to the plane P1 and the sidewall(s) 32a may be sloped or otherwise structured with respect to the plane P1 and the floor 36 so that the sidewalls 32a converge toward the depression floor 36. This structure may aid in directing or funneling igniter activation by-products toward a vent passage 42 (described below) formed in the housing outer wall 24.

The outer wall 24 may include a vent passage 42 formed therein. The vent passage 42 is a through-opening extending completely through the outer wall 24 and structured to enable fluid communication between the exterior 28 of the housing 22 and the interior 26 of the housing 22, where the airbag 30 is positioned prior to inflation. As used herein, the term “through opening” refers to an opening that extends completely through an element from a first side of the element to a second side of the element opposite the first side.

The vent passage 42 may be structured to facilitate propagation of igniter activation by-products (such as flaming, gases, shockwaves, heat energy and/or other by-products) from an enclosure 44 defined by the housing outer wall 24 and an cover 48 applied to the outer wall, into the housing interior 26. In one or more arrangements, the vent passage 42 may be positioned inside the depression 32 and extend through the floor 36 of the depression 32. The housing outer wall 24 may also include another through-opening 50 in the form of a tether slot enabling passage of the airbag tether 38 therethrough. In one or more arrangements, the housing 22 may be formed from a metallic material. Any other suitable material or materials may be used.

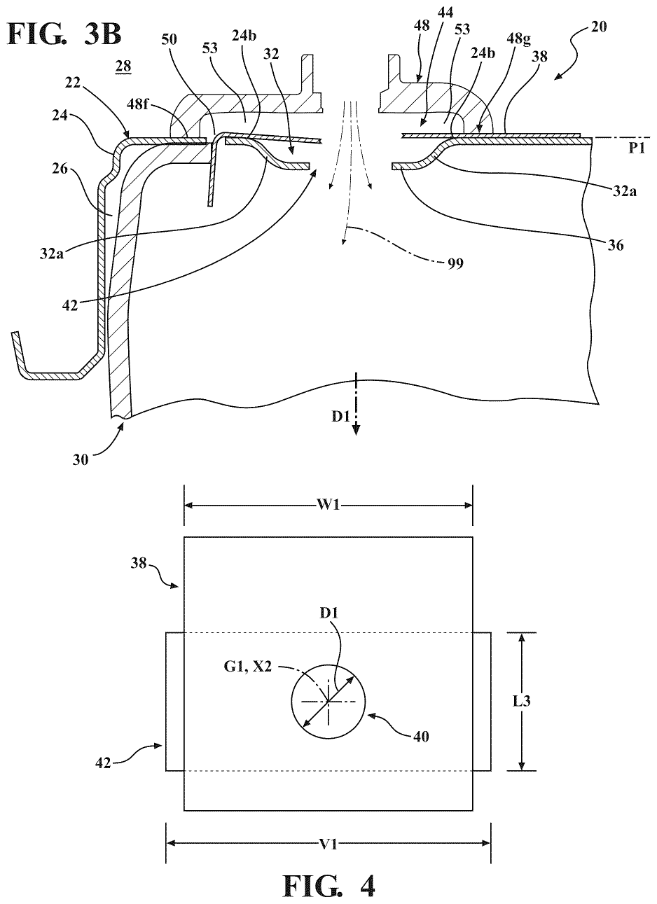

In one or more arrangements, the cover 48 may be attached to an exterior of the housing 22 along the outer wall 24. The cover 48 may include a through-opening 52 for gas-tight securement of the igniter 40 therein. As seen in FIG. 3, the cover 48 may be attached to the outer wall 24 so as to enclose the depression 32. “Enclosure of the depression” means that the cover 48 is attached to (or spaced apart from) a portion of the outer wall 24 where the depression 32 begins. When attached to the housing outer wall 24, the outer wall 24 and the cover 48 may combine to define an enclosure 44 positioned exterior of the housing 22. the cover 48 may be attached to the outer wall 24 so as to seal (or substantially seal) the enclosure 44 against escape of flaming, gases, shockwaves, heat energy and/or other by-products of igniter activation (i.e., so that flaming, gases, shockwaves, heat energy and/or other by-products of igniter activation are confined (or substantially confined) within the enclosure 44 except for the pathway out of the enclosure 44 provided by the vent passage 42 formed in the housing outer wall 24).

In one or more arrangements, a groove 48g may be formed in an edge 48e of the cover 48 to enable passage of the tether 38 between the cover 48 and outer wall 24, from an exterior of the enclosure 44 into the enclosure. The flaming and other by-products of igniter activation may be prevented from exiting enclosure 44 between the cover 48 and the outer wall 24 by the seal(s) formed by attachment of the cover 48 to the outer wall 24 and by the presence of portions of the tether 38 extending into the tether groove 48g between the cover 48 and the outer wall 24.

As seen in FIG. 3, the cover 48 may be structured so that the enclosure 44 includes one or more overlap region(s) 53 formed when the cover 48 is secured to the housing outer wall 24. An “overlap region” is a volume of space extending along and above a region defined by edges 48f of the cover 48 contacting the outer wall and edges 24b of the outer wall 24 bounding the depression 32 when the cover 48 is attached to the housing outer wall 24. The overlap region(s) 53 may accommodate expansion and dissipation of flaming and may contribute to dissipation of shock waves that are not directed into separating the tether 38. For example, the overlap region(s) 53 may create one or more “dead spaces” for receiving reflected, scattered and/or interfering shockwaves therein. The optimal size, shape and/or other characteristics of the overlap region(s) 53 for providing desired flaming dissipation and shockwave dissipation effects may be determined analytically and/or by experimentation using known methods.

As seen in FIGS. 1-3, the cover 48 may be structured and secured to the outer wall 24 so that the igniter 40 is positioned opposite and overlies the vent passage 42 when the igniter 40 is secured in the cover through-opening 52 and the cover 48 is secured to the outer wall 24. In one or more arrangements, the cover 48 may be formed from a polymer material. Any other suitable material or materials may be used.

Igniter 40 may be operatively connected to the housing 22. In one or more arrangements, the igniter 40 may be secured along the exterior 28 of the housing 22. The term “operatively connected,” as used throughout this description, can include direct or indirect connections, including connections without direct physical contact. In the embodiment shown in the drawings, the igniter 40 is connected to the housing 22 via gas-tight attachment of the igniter 40 to the cover 48 and attachment of the cover to the housing outer wall 24.

The igniter 40 may be specified and positioned to separate the tether 38 as described herein. A separate airbag inflator 41 may be operatively connected to the housing 22 and to the airbag 30 so as to enable fluid communication with an interior of the airbag 30 for inflation of the airbag. The igniter 40 may be positioned close to the tether 38 so that shockwaves generated by activation of the igniter 40 will cause separation of the tether 38 essentially as soon as the shockwaves are generated. “Separation of the tether” involves separation of the tether completely through a width dimension of the tether so that a single piece of tether material becomes at least two pieces of tether material at a location where the separation occurs. Close proximity of the igniter 40 to the tether 38 may help to ensure maximum energy transfer from the activated igniter 40 to the tether 38. In particular, it has been found that positioning of the igniter 40 so that a 0.0-3.0 millimeter gap is provided between the igniter 40 and the tether 38 prior to activation of the igniter 40 helps facilitate maximum energy transfer from the activated igniter 40 to the tether 38.

An inflatable airbag or cushion 30 is received in a folded condition in the housing interior 26. An airbag inflator (not shown) may be operatively connected to the airbag 30 for inflating the airbag responsive to a control signal. The airbag 30 may be structured to inflate in direction D1 when activated.

The tether 38 may extend between the housing exterior (along the housing outer wall 24 as shown) and the cover 48. The tether 38 may extend into the enclosure 44 and overlie the depression 32 between the igniter 40 and the depression 32. The tether 38 may also extend between the igniter 40 and the vent passage 42, overlying the vent passage. The tether 38 may then exit the enclosure 44 through the outer wall tether slot 50 into the housing interior 26 where it may be secured to the airbag 30 inside the housing interior 26 to block the vent passage 42 prior to separation of the tether 38. An opposite end of the tether (outside the housing interior 26) may be secured to the housing 22 or to another portion of the vehicle in which the airbag module resides.

FIG. 3B is the schematic cross-sectional view of FIG. 3, showing activation of the igniter and the resulting separation of the tether prior to (or simultaneous with) activation of the airbag inflator 41 and after the start of airbag deployment. Referring to FIG. 3B, in operation, when it is desired to separate the tether 38 to disable its restriction on airbag deployment, an activation signal may be sent to the igniter 40. The igniter 40 may then activate, producing shockwaves which separate the portion of the tether 38 adjacent the igniter 40. This separates the tether 38 into two pieces, enabling the portion of the tether attached to the airbag 30 to move with the airbag in a known manner as the airbag inflates in direction D1. Igniter by-products 99 may be prevented from exiting enclosure 44 between cover 48 and outer wall 24 by seal(s) formed between cover 48 and outer wall 24 and by presence of portions of tether 38 extending through the cover tether groove 48g. Flaming, shockwaves and other by-products 99 of igniter activation may be initially confined to the enclosure 44 and may exit the enclosure through the vent passage 42 and into an interior of the airbag during or after airbag deployment. Prior to exiting the enclosure 44 through the vent passage 42, portions of the shockwaves may impinge on converging sidewall(s) 32a of the depression 32 and reflect from the sidewall(s) 32a toward each other and toward other portions of the enclosure 44 defined by the outer wall 24 and the cover 48. The geometries of the various internal surfaces of the enclosure 44, the materials from which the enclosure surfaces are formed and/or features such as the overlap regions 53 may be structured to promote absorption of the shockwaves, scattering of the shockwaves and/or mutual interference between the reflected and/or propagating shockwaves, causing most of the shockwaves to dissipate or cancel after separating the tether 38 and prior to passage of the shockwaves into the housing interior. Scattering and interference of the shockwaves may also delay propagation of the shockwaves into the housing interior, thereby helping to ensure that the airbag is at least partially deployed prior to passage of the shockwaves into the housing interior. This may help minimize effects on the airbag due to passage of the shockwaves and other igniter by-products 99 into the housing interior 26 and the inflating/inflated airbag 30.

FIG. 4 is a schematic plan view of the portion of the airbag module shown in FIGS. 1-3A, showing relative sizes and spatial relationships of the vent passage 42, igniter 40, and tether width W1 in accordance with one or more arrangements described herein. In one or more arrangements, the tether width W1 may be 27 millimeters plus or minus an applicable tolerance value (e.g., ±2 millimeters). The vent passage 42 may have a rectangular shape with a width V1 of at least 1 millimeter greater than tether width W1 and a length L3 of at least 1 millimeter greater than the igniter outer diameter D1. The igniter 40 may have a cylindrical shape with an outer diameter D1 of 8.0 millimeters ±1.0 millimeter. In addition, the cover 48 with the igniter 40 attached thereto may be structured to be positionable and securable with respect to the vent passage 42 so than an axis G1 extending through a center of the igniter outer diameter D1 is coaxial with an axis X2 extending through a geometric center of the vent passage 42, to within a radius 1 millimeter of the axis X2.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. The airbag module of claim 6, wherein the airbag housing includes a through-opening formed in an outer wall of the housing, wherein the tether extends between the igniter and the through-opening, and wherein at least a portion of the shockwaves pass through the through-opening and into an interior of the housing.

2. The airbag module of claim 6, wherein the igniter is secured to the cover.

3. The airbag module of claim 1, wherein the igniter is spaced apart a distance in a range of 0.0-3.0 millimeters from the tether prior to activation of the igniter.

4. The airbag module of claim 1, further comprising:
a folded airbag positioned in the housing interior; and
an airbag inflator operatively connected to the airbag for inflating the airbag,
wherein the airbag module is structured so that at least a portion of the shockwaves pass through the throat and into an interior of the airbag after separation of the tether.

5. The airbag module of claim 6, wherein the igniter is positioned along an exterior of the housing.

6. An airbag module comprising:
an airbag housing including a depression formed in an outer wall of the housing along an exterior of the housing;
a cover attached to the housing along an exterior of the housing, the housing and the cover combining to define an enclosure positioned exterior of the housing; and
an igniter operatively connected to the housing so that activation of the igniter produces shockwaves causing separation of a tether extending into the enclosure, the enclosure being structured to confine flaming generated by activation of the igniter,
wherein a portion of the tether extends between the igniter and the depression.

7. The airbag module of claim 10, wherein the igniter extends into an opening formed in the cover.

8. (canceled)

9. The airbag module of claim 10, wherein the cover overlies the through-opening.

10. An airbag module comprising:
an airbag housing including a through-opening formed in an outer wall of the housing and structured to enable fluid communication between the enclosure and an interior of the housing;
a cover attached to the housing along an exterior of the housing, the housing and the cover combining to define an enclosure positioned exterior of the housing; and
an igniter operatively connected to the housing so that activation of the igniter produces shockwaves causing separation of a tether extending into the enclosure, the enclosure being structured to confine flaming generated by activation of the igniter, wherein a depression is formed in the outer wall along the housing exterior, and wherein the through-opening resides inside the depression.

11. An airbag module comprising:
an airbag housing;
a cover attached to the housing along an exterior of the housing, the housing and the cover combining to define an enclosure positioned exterior of the housing; and
an igniter operatively connected to the housing so that activation of the igniter produces shockwaves causing separation of a tether extending into the enclosure, the enclosure being structured to confine flaming generated by activation of the igniter,
wherein a depression is formed in an outer wall of the housing along the housing exterior, and wherein the cover encloses the depression.

12. The airbag module of claim 11, wherein the cover is structured to form an overlap region with the housing.

13. The airbag module of claim 11, wherein the igniter extends into an opening formed in the cover.

14. The airbag module of claim 6, wherein the igniter extends into an opening formed in the cover.
